(19) United States
(12) Patent Application Publication
(10) Pub. No.: US 2012/0141955 A1
(43) Pub. Date: Jun. 7, 2012

(54) HYBRID DENTAL IMPLANT

(75) Inventor: Do-Gyoon Kim, Dublin, OH (US)

(73) Assignee: THE OHIO STATE UNIVERSITY, Columbus, OH (US)

(21) Appl. No.: 13/310,934

(22) Filed: Dec. 5, 2011

Related U.S. Application Data
(60) Provisional application No. 61/419,333, filed on Dec. 3, 2010.

(51) Int. Cl. A61C 8/00

(52) U.S. Cl. 433/174

(57) ABSTRACT

The present invention provides for a hybrid dental implant having a screw body with at least one external thread, which comprises an upper portion with an open ceiling configured to receive an unhardened cement, a middle portion having an inner cavity and one or more side openings extending from the inner cavity, wherein the open ceiling is in communication with the inner cavity to form a hollow inner channel, which allows the unhardened cement to move through the side openings and to penetrate the surrounding bone; and a lower portion with a closed floor. It also provides for a method of installing a hybrid dental implant into a bone.

This application claims the benefit of U.S. Provisional Application No. 61/419,333 filed Dec. 3, 2010. This prior application is hereby incorporated by reference.

### STATEMENT REGARDING FEDERALLY-SPONSORED RESEARCH AND DEVELOPMENT

(Not Applicable)

### REFERENCE TO AN APPENDIX

(Not Applicable)

### FIELD OF THE INVENTION

This invention relates generally to the field of dental implants that provide bone cement stability augmentation to allow for immediate post-implant masticatory loading and to promote osseointegration.

### BACKGROUND OF THE INVENTION

Currently, a dental implant is a “root” device used in dentistry to support restorations that resemble a tooth or group of teeth to replace missing teeth. The dental implants, abutments, and dental prostheses are collectively called dental restorations or implant systems that resemble a tooth or group of teeth (referred to as “restoration” or “implant system”) as replacements for missing teeth. A dental implant generally appears similar to an actual tooth root and is placed within the bone of the jaw to replace the root of the missing tooth. After the implant surface fuses with the surrounding jaw bone (osseointegration), dental abutments and other dental prostheses, such as crowns, implant-supported bridges or dentures, can be installed. The dental abutments and prostheses then allow a patient to use the restorations for chewing (also called masticatory loading).

The process of placing the dental implants into the jaw bone of a patient is called dental implantation, and it is a very vigorous surgical procedure, resulting in bone damage at the bone-implant interface. A relatively long healing period follows this dental implantation process, which lasts at least about two to three months and may extend to six months. During the healing period, (1) the bone damage is repaired and replaced with new bone tissues (active biological bone remodeling); and (2) direct bone ingrowth or fusion between the implant surface and the bone tissue surrounding the implant is also achieved (osseointegration). If the healing time is too short before any masticatory force is applied on the implant, the implant might risk failure because of the bone damage in the pre-existing interfacial bone, weak new bone tissues, and unstable bone-implant interface with partial osseointegration. The masticatory force applied on an insufficiently healed implant creates excessive micro-motion between bone and implant surface, resulting in fibrous tissue development at the interface which might block further osseointegration and cause eventual failure of the implant system.

To prevent or reduce any possible direct masticatory force being applied on the implant, the installed implant is protected under a healing cap during the healing period. After a sufficient healing period, a second surgery is conducted to install an abutment and prosthesis (artificial tooth crown). The combination of these two surgeries results in an implant system that is regarded as a dental replacement for the missing tooth.

Even if a long healing period is allowed after implantation, some bone diseases, such as osteoporosis and periodontal diseases, etc., might weaken the surrounding bone to the extent that not enough suitable bone tissue is left to support the implant system under masticatory loading and to ensure sufficient osseointegration at the bone-implant interface. If any high masticatory force is applied on the implant system, the weak and diseased bone-implant interface is likely be fractured. Therefore, the success of a dental implantation procedure is typically measured by the osseointegration of the bone-implant interface. The sufficiently osseointegrated bone-implant interface provides enough mechanical stability for the implant to withstand the masticatory force generated from daily chewing activities.

In sum, the current dental implant and restoration process for the installation of the dental implant system (restoration) has the following three major problems:

1. A long healing period is required after the dental implantation and prior to normal mastication for osseointegration of bone-implant interface.

2. A painful secondary surgery is required to install the prosthesis after the long healing period of the dental implantation.

3. There is a high risk of failure for the implant system, even after a long healing period, if the bone surrounding the implant is weak or diseased, such as by osteoporosis, periodontitis, or necrosis, etc.

The main cause of the above three problems is that the bone-implant interface has insufficient mechanical stability to support the implant system under repetitive masticatory forces from daily chewing activities. The weak mechanical stability of the bone-implant interface is the result of inadequate amount of bone surrounding the implant and/or insufficient osseointegration.

Attempts were made to utilize bone cement to be the main material for a dental implant with possibly augmented stability. In a 1979 study by Peterson et al. (J. Dent. Res. Pp. 489-496, January 1979), polymethylmethacrylate (PMMA) dental implants were inserted into dogs. More than about 50% of these implants failed, which were attributed to mechanical weakness of the implant, thin buccal cortical bone, and excessive implant-gingiva interface. Thus, the study showed that PMMA material fashioned into a porous rooted implant would not consistently withstand biological and mechanical stresses.

After the 1979 study by Peterson et al., repeated attempts to use PMMA cement to augment dental implants have failed. The reason for failures was found to be (1) the lack of bioactivity and bonding between the cement and the bone, which results in an intervening fibrous layer between the bone and PMMA; (2) thermal necrosis caused by a highly exothermic setting reaction; (3) chemical necrosis and tissue toxicity to the residual monomer and N,N-dimethyl-p-toluidine (DMPT) release; (4) the hardened cement is a brittle material with insufficient fatigue resistance that is susceptible to failure when tensile forces are present; and (5) a significant volumetric shrinkage of the cement during polymerization, which induces stresses and undermines the integrity of the cement-bone interface, resulting in aseptic loosening after a long-term implantation.

Currently, although PMMA cement is widely used for orthopedic surgeries, it is not being used in dental implant systems. During the orthopedic surgeries, the available bone surfaces and the filling area for the bone cement are often hundreds of times larger than that of a dental implant. Often, a dental patient might not have much jaw bone left adjacent to the dental implant. As such, high setting temperature and/or other shortcomings of bone cements, such as PMMA cement, become more detrimental to the success of the implant.

In addition, although PMMA bone cement augmentation has been known in orthopedic surgery, it has issues for some orthopedic applications and for long term stability. For example, some drawbacks, such as lack of adhesion to bone surfaces (no bioactivity), poor biocompatibility, absence of osteoconductivity, short of biodegradability, weaker implements than cortical bone, high exothermic polymerization reaction, and monomer toxicity, limit its applications, particularly in spinal surgery. More importantly, PMMA or other similar bone cement is not suitable for maintaining biomechanical properties after implantation in the body for a long time.

### BRIEF SUMMARY OF THE INVENTION

There exists a need to have a dental implant that (1) enhances the immediate post-implantation stability of the installed implant; and (2) provides for the installation of the entire dental implant system, including the dental abutment and prosthesis, in only one surgical procedure. The present invention meets this need by providing a hybrid dental implant that is simple, inexpensive, and easy-to-use. The hybrid dental implant improves the immediate stability of the installed implant to withstand an immediate masticatory loading, and enables strong osseointegration at the bone-implant interface even for weak and diseased jaw bones surrounding the implant.

The hybrid dental implant includes a screw body with one or more external threads, including an upper open portion with an open ceiling configured to receive unhardened bone cement, a middle portion having an inner cavity and one or more side openings extending from the inner cavity, wherein the open ceiling is in communication with the inner cavity to form a hollow inner channel, which allows a portion of the unhardened bone cement to move through the side openings and to penetrate into the surrounding bone; and a lower portion with a closed floor. The hollow inner tunnel extends from the upper portion through the middle portion to the lower portion.

Preferably, the upper portion of the hollow inner channel is configured to couple with a bone cement syringe. The side openings of the middle portion allow for the unhardened bone cement to penetrate into the bone surrounding the implant, and then harden to anchor the implant to the surrounding bone. This bone cement augmentation provides adequate initial stability to the implant during the healing period as the outer threaded parts of the implant slowly osseointegrate with the adjacent bone to provide the implant with an increasing level of permanent stability. Preferably, the middle portion occupies no more than about 50% of the entire length of the implant. More preferably, the middle portion occupies no more than about 40% of the entire length of the implant. In some embodiments of the present invention, the side openings of the middle portion are formed of two or more columns.

According to some embodiments, the bone cement is an injectable, biocompatible bone filling or substitution material. Unlimited examples of the bone cement of the present invention are PMMA cements, modified PMMA cements, calcium phosphate cements (CPCs), glass-ionomer cements (GICs), composite resin cements, and osteoinductive cement, including CPCs and ceramics, etc. Preferably, the bone cement comprises a PMMA cement with one or more suitable additives so as to ensure a suitable setting temperature for use with the dental implant.

According to some embodiments, the lower portion of the implant comprises one or more self-tapping cuts at a front end of the lower portion.

According to some embodiments, the implant of the present invention has a coating of bone inducing material on at least a portion of an outer surface of the implant.

The present invention also provides a method for installing a hybrid dental implant into bone, which includes the following steps: First, screwing a hybrid implant with a screw body having at least one external thread into a bored hole in the bone. Then, injecting a suitable amount of unhardened bone cement into an open ceiling of the implant, thereby pushing the cement into an upper portion of the implant, whereby the cement moves through a hollow inner channel, which is formed of an inner cavity in communication with the open ceiling, into a middle portion of the implant having one or more side openings, through which the cement penetrates the surrounding bone but does not move substantially pass a lower portion of the implant that forms a closed floor.

In some further embodiments, additional steps are added, including waiting for a period of time sufficient to allow the hardening of the bone cement; and attaching a dental abutment and/or prosthesis to the implant.

Moreover, some embodiments of the method might have a step of using a push cylinder to apply pressure on the bone cement to enable it to penetrate cracks and/or spaces in the surrounding bone.

In some alternative embodiments, the present invention provides for a hybrid implant for orthopedic applications. The hybrid implant includes a screw body with one or more external threads, including an upper portion with an open ceiling configured to receive unhardened bone cement, a middle portion having an inner cavity and one or more side openings extending from the inner cavity, wherein the open ceiling is in communication with the inner cavity to form a hollow inner channel, which allows a portion of the unhardened bone cement to move through the side openings and to penetrate into the surrounding bone; and a lower portion with a closed floor. The hollow inner tunnel extends from the upper portion through the middle portion to the lower portion.

In some other alternative embodiments, the present invention provides for a hybrid screw for construction applications. The improved screw includes a screw body with one or more external threads, including an upper portion with an open ceiling configured to receive unhardened construction cement, a middle portion having an inner cavity and one or more side openings extending from the inner cavity, wherein the open ceiling is in communication with the inner cavity to form a hollow inner channel, which allows a portion of the unhardened construction cement to move through the side openings and to penetrate into the surrounding construction material; and a lower portion with a closed floor. The hollow inner tunnel extends from the upper portion through the middle portion to the lower portion. The construction cement refers the cements or binder suitable for attaching the screw to the surface of a construction material, such as Portland cement, masonry cement, pozzolan-lime cement, etc.

### BRIEF DESCRIPTION OF THE SEVERAL VIEWS OF THE DRAWINGS

FIG. 1 contains various perspective views of the invention illustrating (a) the top; (b) middle cut-off view; (c) isometric; (d) front; and (e) the right side view of a preferred embodiment of the hybrid implant of the present invention.

FIG. 2 illustrates a process of bone cement injection into the hybrid implant of FIG. 1: (a) when the implant is placed into the bone; (b) when the bone cement is being injected into the implant; and (c) the bone cement hardens to anchor the implant to the surrounding bone.

FIG. 3 is a graph showing tissue modulus analysis of the images of microcomputed tomography (micro-CT) for the Example, illustrating the effect of bone cement augmentation on the implant-bone interface: (a) the intact interfacial bone; (b) the altered (or weakened/less mineralized) new bone properties during healing after inserting the implant without bone cement; and (c) the altered new bone properties during healing after inserting the hybrid implant of the present invention with the PMMA bone cement.

FIG. 4 is a graph showing equivalent strain to von Mises stress analysis of the images of microcomputed tomography (micro-CT) for the Example, illustrating the effect of bone cement augmentation on the implant-bone interface: (a) the intact interfacial bone; (b) the altered (or weakened/less mineralized) new bone properties during healing after inserting the implant without bone cement; and (c) the altered new bone properties during healing after inserting the hybrid implant of the present invention with the PMMA bone cement.

FIG. 5 is a diagram comparing stiffness based on the Finite Element model (FE) results for the Example based on (a) the intact interfacial bone; (b) the altered (or weakened/less mineralized) new bone properties during healing after inserting the implant without bone cement; and (c) the altered new bone properties during healing after inserting the hybrid implant of the present invention with the PMMA bone cement.

FIG. 6 is a diagram comparing the strain equivalent to von Mises stress based on the Finite Element model (FE) results for the Example based on (a) the intact interfacial bone; (b) the altered (or weakened/less mineralized) new bone properties during healing after inserting the implant without bone cement; and (c) the altered new bone properties during healing after inserting the hybrid implant of the present invention with the PMMA bone cement.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

Patent application Ser. No. 61/419,333 filed Dec. 3, 2010, which is the above-claimed priority application, is incorporated in this application by reference.

Broadly, the present invention provides for a hybrid dental implant with a hollow inner channel, a body with an upper portion, a middle portion with one or more side openings, and a lower portion.

Preferably, the body has a screw shape with at least one external thread, having an upper portion, a middle portion, and a lower portion. The upper portion has an open ceiling configured to receive an unhardened bone cement. The middle portion having the inner cavity and one or more side openings, wherein the open ceiling is in communication with the inner cavity to form a hollow inner channel, which allows a portion of the unhardened bone cement to move through the side openings and to penetrate into the surrounding bone. The lower portion has a closed floor, which prevents the cement from moving substantially past the lower portion. The hollow inner tunnel has an open ceiling, an inner cavity, and a closed floor, extending from the upper portion through the middle portion to the lower portion. The dental system refers to the whole restoration of dental implant, dental abutment, and dental prosthesis, which can be used as a replacement for the missing tooth or teeth.

The side openings of the middle portion allow for the unhardened cement to penetrate into the bone surrounding the implant, and then harden (or set) to anchor the implant to the surrounding bone, which provides at least temporary stability to the implant to withstand the masticatory forces from daily chewing. This anchorage by the bone cement allows for the successful and more rapid osseointegration of the bone to the outer surfaces of the upper and lower portions of the implant even for weak and/or diseased jaw bones. Some portions of the outer surfaces of the middle portion can also osseointegrate with the surrounding bone if they are exposed to the bone.

Briefly stated, the dental implant of the present invention is a simple and inexpensive device to provide a hybrid function of an initial bone cement stability augmentation at the middle portion of the implant, and a later osseointegration of the bone-implant interface at the upper and lower portions of the implant. The initial bone cement stability augmentation enhances the immediate mechanical stability of the implant to the extent that the implant can withstand the masticatory force from daily chewing right after the implantation process, even if the bone surrounding the implant is diseased and/or weak. Therefore, with the hybrid implant of the present invention, the dental abutment and prosthesis can be installed right after the implantation during the same surgery without having to wait for a long healing period. In other words, the entire dental system, including the dental implant, abutment and prosthesis, can be installed in one surgical procedure using the hybrid implant of the present invention. The bone cement augmentation at the middle portion of the implant supports the entire implant system under daily masticatory loading, and enables the rapid healing and osseointegration of the bone-implant interface for the implant. A patient can then have an implant installed despite a weak diseased jaw bone, in addition to avoiding the long healing period after the implant installment and the second surgery to install an abutment and prosthesis.

A typical dental implant consists of a titanium screw (resembling a tooth root) with a roughened or smooth surface. The hybrid dental implant of the present invention is a dental implant into which the bone cement can be injected. The implant preferably has a screw body of any suitable shape with one or more external threads. However, other shapes and/or types of dental implant bodies can also be used so long as their surfaces can be osseointegrated with the bone at the bone-implant interface, and allow for the injection of the bone cement for initial bone cement stability augmentation. The screw shaped body is preferred because it has external threads that provide more mechanical stability of the implant system and more surface area for osseointegration with the surrounding bone. In addition, the implant surfaces may be modified by plasma spraying, anodizing, etching, or sandblasting to increase the surface area and osseointegration potential of the implant.

The dental implant of the present invention may be made of titanium or other suitable biocompatible materials. Titanium is a preferred material because the bone is observed to adhere to titanium surfaces (“osseointegration”). Suitable titanium can be pure titanium or a titanium alloy. Commercially pure titanium is available in four grades depending upon the amount of carbon and iron contained therein. The commercially available titanium alloy is grade 5 titanium, Titanium 6AL-4V (signifying the titanium alloy containing 6% aluminum and 4% vanadium), which offers similar osseointegration levels as that of commercially pure titanium with better tensile strength and fracture resistance.

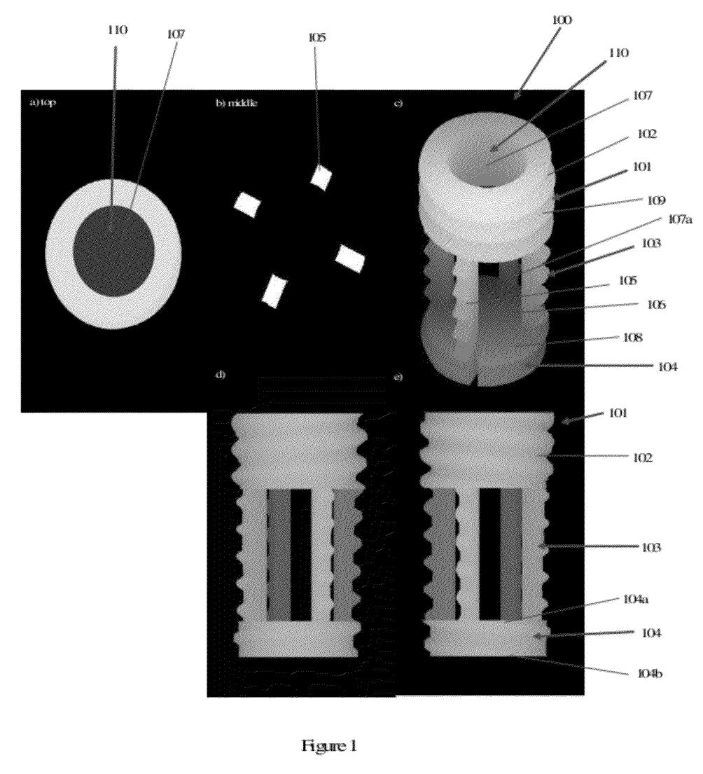

As illustrated in FIG. 1, a preferred embodiment of the implant of the present invention is shown generally as 100, having a screw body 101 with one or more external threads 109, and a hollow inner channel 110 with an open ceiling 107 (FIG. 1a), an inner cavity 107a, and a closed floor 108 (FIG. 1c). The implant 100 is characterized by an upper portion 102 (FIGS. 1c-1e); a middle portion 103 with four columns 105 spaced evenly around the hollow inner channel 110 to form four longitudinal side openings 106; and a lower portion 104. The open ceiling 107 of the hollow inner channel 110 is located at the upper portion 102; the inner cavity 107a is located at the middle portion 103; the closed floor 108 is located at the lower portion 104. The open ceiling 107 is in communication with the inner cavity 107a to form the hollow inner channel 110, which is configured to receive an unhardened bone cement.

The implant 100 is intended to be inserted into a bored hole in the jaw bone for permanent anchoring of artificial teeth, tooth-bridges and other dental prostheses. The insertion starts with screwing the lower portion 104 of the implant into the bore hole until the entire implant, including the upper portion 102, is screwed into the bore hole of the bone. Preferred shapes of the dental implant are the shapes which assist in the insertion of the implant, such as substantially frustoconical, substantially cylindrical (FIGS. 1c-1e), or any other suitable shape(s). For example, frustoconical shape with tapering threads allows the front end to be screwed into the pre-prepared bone hole more easily and provides for tighter insertion or coupling with the bone initially. Therefore, the initial tight coupling of the outer threaded parts of the implant with the adjacent bone provides for the initial mechanical stability of the implant during the healing period. For the purpose of this invention, the bone cement is added to augment this initial stability. The outer threaded parts of the implant can be called “the threaded parts of the implant,” “implant thread,” or “screw thread” interchangeably.

The upper portion 102 has the open ceiling 107, through which the bone cement can be injected into the hollow channel 110 of the implant 100 once the implant 100 is in the jaw bone. A suitable amount of the bone cement is injected into the channel 110, preferably through the open ceiling 107, so that the bone cement can penetrate into the cracks and/or spaces in the surrounding bone through the side openings 106 at the middle portion 103 of the implant, such as the inter-trabecular space(s). The cracks and/or spaces in the surrounding bone are often created by the implantation process. The amount of the bone cement needed to augment the implant is determined by the size of the implant, the volume of the hollow inner channel, the size and number of the cracks and/or spaces in the surrounding bone, and the number and size of side openings 106 at the middle portion 103. The rate of injection and the amount of the bone cement injected into the implant should be carefully pre-determined to prevent too much bone cement from moving into the cracks in the surrounding bone, such as the inter-trabecular space. Too much bone cement can put too much force on the bone already damaged during the initial preparation process.

For purposes of the present invention, the middle portion 103 has at least one side opening 106 to allow side penetration of the bone cement into the surrounding bone. Preferably, the middle portion has three or four side openings 106, which are preferably evenly spaced so as to allow for more even distribution of bone cement to anchor to the surrounding bone.

As illustrated by FIG. 1, four side openings 106 of the middle portion 103 are formed by four columns 105 positioned evenly around and extended at a preferred 90° angle (FIG. 1b) from the inner cavity 107a of the hollow inner channel 110. The preferred 90° angle provides a wider side opening for the bone cement to move through to get in touch with the surrounding bone. Preferably, each one of the side openings 106 has a wedge-shape with its outer diameter being larger than that of its inner diameter (FIG. 1b). This wedge-shaped side opening provides more accessible space for the bone cement to penetrate into a larger area of the surrounding bone, resulting in a stronger anchorage of the implant to the bone. Correspondingly, the column of the middle portion has an outer surface area slightly larger than, equal to, or slightly smaller than the column's inner surface area. Of course, the shapes of columns can be similar or different so long as they provide sufficient support to the implant and the opening.

Alternatively, to provide more surface area for the middle columns to potentially osseointegrate with the surrounding live bone, the outer diameter of the column can be much larger than its inner diameter. As the result, the side opening's outer diameter might be essentially the same as or smaller than the side opening's inner diameter. So long as the bone cement can be pushed or moved through the side openings to penetrate into the bone sufficiently to provide enough temporary anchorage of the implant to the bone, it might be more desirable to have more osseointegration at the middle portion to offer more long-term stability to the implant.

In addition, the four middle columns can alternatively be twisted in the manner of a helix along the angle of thread in order to reduce shear resistance by the torque force generated during the screw-in process of the implantation.

The outer surfaces of the columns preferably have one or more external threads 109, which provide mechanical stability of the implant system and more surface area for osseointegration with the surrounding bone. The inner surfaces of the columns can be smooth, rough, or threaded. It is possible that the bone cement might cover up part or all of the outer surface of the middle portion. As the primary objective of the middle portion is to provide bone cement stability augmentation to the implant, any osseointegration with the bone to the outer surface of the middle portion is an added benefit. The middle portion 103 with its bone cement augmentation is to enhance the initial stability of the implant by decreasing the amount of micro-motion between the bone and the implant surface, which enables rapid osseointegration at the bone-implant interface adjacent to the upper 102 and lower 104 portions of the implant. The osseointegration with surrounding bone tissue mainly comes from the upper 102 and lower 104 portions of the implant 100.

It is important to note that the goal of the bone cement augmentation of the middle portion is to provide temporary initial stability to the implant, while that of the osseointegration of the upper and lower portions of the implant is to provide long term permanent stability to the implant. Therefore, the middle portion is preferably sized just big enough to enhance the initial stability of the implant sufficiently to promote rapid osseointegration of the implant through its upper and lower portions mostly, and to withstand masticatory forces from daily chewing activities. To accomplish that objective, the middle portion preferably occupies no more than about 50% of the entire length of the implant, more preferably no more than about 30-40%.

The upper 102 and lower 104 portions preferably have one or more external threads 109 on their outer surfaces to provide more mechanical stability and surface areas to osseointegrate with the surrounding bone. The lower portion 104 has two contact areas with the live bone: one is the front end surface preferably with the self-tapping cuts, and the other is the vertical side surface. The upper portion 102 has only one contact area with the live surrounding bone: the vertical side surface(s). In order to ensure that the stability of the implant is suitably balanced between the temporary immediate stability (screw thread and cement augmentation) and the long term stability (osseointegration), the upper portion 102 is preferably longer than that of the lower portion 104, such as in a ratio of 5:3. In other words, the longer upper portion 102 allows for more vertical outer surface of the implant to osseointegrate with the surrounding bone, which balances and provides more stability to the overall implant.

The upper portion 102 has an optional collar and an attachment means for attaching a dental prosthesis thereto. As shown by FIG. 1c, the attachment means is the open ceiling within the upper portion. The open ceiling is optionally threaded (not shown) to accept threaded inserts. Of course, the attachment means may be of any other suitable design for attaching a dental prosthesis such as a male part extending upwards from the upper portion. Optionally, the male part may be threaded.

The lower portion of the implant preferably has one or more self-tapping cuts at the front end of the lower portion, which facilitate the insertion of the implant into the bored hole in the bone tissue. The self-tapping cuts can be longitudinal cavities having cutting faces with cutting edges to provide self-tapping. A cutting edge may have a plurality of cutting teeth. Other suitable types of self-tapping cuts can also be used. In addition, these cutting edges can provide more implant-bone interface area for osseointegration.

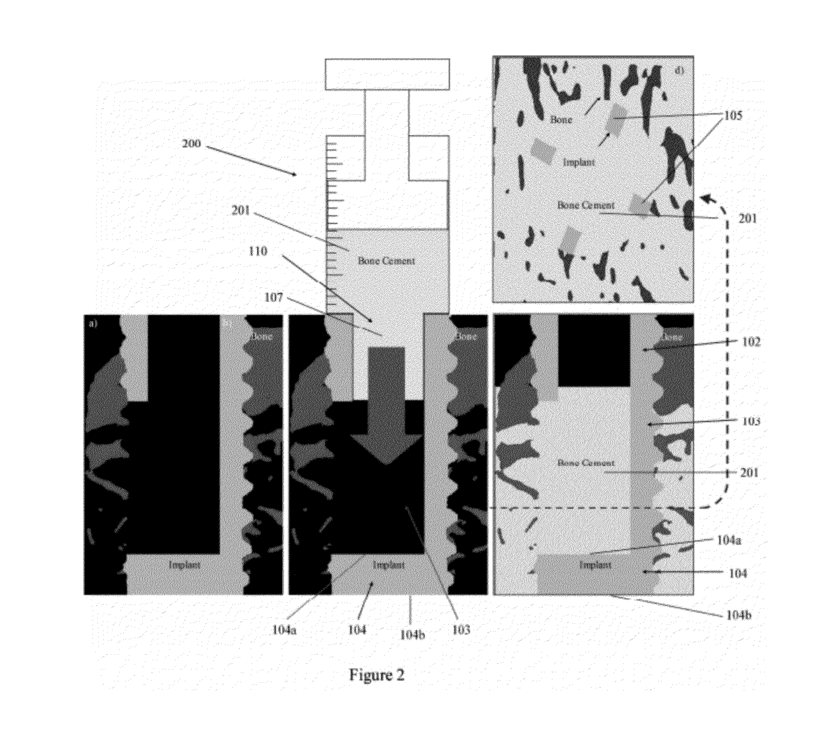

For the purpose of the present invention, as shown by FIG. 2b, the open ceiling 107 is adapted to receive the bone cement 201 from a bone syringe 200 into the hollow inner channel 110 of the implant 100. Thus, the open ceiling 107 serves as an inlet for the unhardened bone cement to move into the hollow inner channel 110 to the middle portion 103, and then to move through the side openings 106 of the middle portion 103 to penetrate into the surrounding bone.

The hollow inner channel 110 stops at the closed floor 108 within the lower portion 104 of the implant 100. The closed floor 108 can be the inner end 104a (also called the inner surface) of the lower portion 104, or it can extend into the lower portion 104, such as with an indented surface. The front end 104b (also called the outer surface) of the lower portion 104 is closed to prevent an outflow of the bone cement through the bottom of the lower portion into the bone, and to provide more surface area for osseointegration. Some of the bone cement might spread from the side openings of the middle portion into parts of the outer side surfaces of the lower portion. Therefore, a part of the lower portion, the side surfaces, might not be exposed to the live bone. The closed floor is configured to ensure at least the front end 104b of the outer surface of the lower portion is exposed to live bone for osseointegration. Osseointegration at the bone-implant interface of the front end of the lower portion together with the osseointegration at the upper portion provide for overall long term stability for the implant.

The hybrid implant of the present invention may be coated with a material to facilitate healing and/or bone growth, and/or the implant can be treated in a suitable manner to increase the outer surface area of the implant. For instance, the outer surfaces of the implant may be coated with a bone inducing/conducting material, such as hydroxyapatite, thereby providing a matrix for bone growth. Preferably, the coating will extend over the entire length of the external thread of the implant, including the upper, middle, and the lower portions. As the wound heals, the hydroxyapatite may be resorbed into the bone. In another embodiment, a titanium plasma spray (TPS) is applied to the outer surfaces of the implant, again, preferably over the entire length of the external thread of the implant. In yet another embodiment, the implant is treated with resorbable blast media (RBM) comprising titanium beads and hydroxyapatite. Preferably, the RBM treatment applies to the upper and lower portions of the implant. All of these treatments are preferably applied as a final step to manufacturing the implant. In the latter two cases, the treatment roughens the surface of the implant, thereby increasing the surface area of the implant. Of course, other suitable coatings and treatment may be used as well.

The present invention also provides a method for installing a hybrid dental implant into bone, which includes the following steps: First, screwing a hybrid implant with a screw body having at least one external thread into a bored hole in the bone. Then, injecting a suitable amount of unhardened bone cement into an open ceiling of the implant, thereby pushing the cement into an upper portion of the implant. The cement moves through a hollow inner channel, which is formed of an inner cavity in communication with the open ceiling, into a middle portion of the implant having one or more side openings, through which the cement penetrates the surrounding bone but does not move substantially past a lower portion of the implant that forms a closed floor.

Once a suitable amount of the cement is introduced into the implant and into the surrounding bone, the rest of the implant or restoration system can be installed in the same surgical procedure by adding the following steps: waiting for a period of time sufficient to allow the hardening of the bone cement; and attaching a dental abutment and/or prosthesis to the implant. In some cases, there is a need to introduce an additional step of using a push cylinder to apply pressure on the bone cement to enable it to penetrate cracks and/or spaces in the surrounding bone.

The process of “inserting the hybrid dental implant into a bone” typically has two steps: (1) boring a pilot hole of an appropriate depth into the dental patient's jaw bone; and then (2) screwing the implant into place in the pilot hole, preferably using a self-tapping cut or cuts of the lower portion. These boring and screwing processes normally generate many bone fragments along with blood and other debris. It is necessary that after the implant is inserted, the bone fragments/chips, blood and other debris are vacuumed out by using any commercially available standard dental vacuuming device, preferably through the open ceiling 107 of the upper portion 102. This vacuuming process cleans off bone, blood and debris from around the implant, leaving cracks and/or spaces in the bone surrounding the implant, such as trabeculae spaces.

After the implant is inserted into the bone and the debris is vacuumed off, the bone cement is injected into the open ceiling 107 of the hollow inner channel 110 of the implant by using a suitable syringe. Through the hollow inner channel, the bone cement is pushed and/or moved into the middle portion, spreading through the side openings 106 into the cracks and/or spaces of the surrounding bone generated during the above installation and vacuuming processes. The neck fitting of the syringe preferably has an outer diameter adapted to fit into the open ceiling 107 as shown in FIG. 2, usually around 2 mm diameter.

The process of bone cement injection is determined by the bone cement's injectability, setting time, polymerization temperature, and viscosity. If the bone cement is too viscous, a push cylinder might be needed to help the bone cement penetrate the cracks and/or spaces of the surrounding bone. Setting time is defined as the time elapsed from the end of mixing to the time when the cement is hardened. Along with the setting time, viscosity is one of the main factors that influence the injectability of the bone cement, which is often in paste form. To improve the injectability of the bone cement, lower viscosity is favorable. Viscosity is typically calculated from the measured force-displacement values and the Hagen Poiseuille formula. The injectability is typically defined as the time needed for the cement to reach a viscosity requiring 150N for injection. Together, the bone cement's injectability, setting time and viscosity determine whether or not the cement can be physically placed into the installed implant within a suitable time—the time that it takes the cement to set or harden.

On the other hand, the bone cement's polymerization temperature determines whether the bone cement is suitable for the hybrid implant of the invention. If the temperature is too high, bone cell necrosis can occur during and/or after hardening of the bone cement, preventing the necessary osseointegration from taking place later and resulting in implant failure. Suitable temperatures should be around 15° C. to 45° C. or so, which correspond to the temperature around the bone tissue.

Typically, the bone cement is made of polymethylmethacrylate (PMMA) or related compounds. For the purposes of the present invention, the bone cement refers to any injectable, bio-compatible bone filing or substitution material with self-setting (hardening) characteristics, suitable setting temperature, and adequate mechanical stability after setting to support the implant to withstand normal masticatory forces or loading without failure. The terms “bone cement” and “cement” are used interchangeably in the present application. For the purpose of this invention, the terms “bone cement” and “cement” also refer to “unhardened bone cement” or “unhardened cement.”

Unlimited examples of the bone cement of the present invention are PMMA cements, modified PMMA cements, calcium phosphate cements (CPCs), glass-ionomer cements (GICs), composite resin cements, osteoinductive cements, including CPCs and ceramics etc., and a mixture or combinations thereof. Osteoinductive cements usually have bone-inducing agents, such as bone morphogenetic protein (BMP).

Suitable additive materials can be used to reduce the viscosity of the bone cement, lengthen the setting time, and increase injectability of the bone cement. For example, after adding disodium phosphate solution to the cement paste of both amorphous calcium phosphate (ACP) and dicalcium phosphate dihydrate (DCPD), the injectability and the setting of the ACP+DCPD bone cement system is augmented. On the other hand, the addition of citric acid decreases the setting time and the injectability slightly. The shortened setting time with acceptable injectability might provide a dental surgeon more flexibility in some cases.

Calcium phosphate cement (CPC) is a blend of various calcium phosphate powders that form an apatite phase or brushite when they are set or hardened. CPC that forms hydroxyapatite (HA) during hardening is called apatite cement, and CPC that forms brushite during setting is called brushite cement. CPCs are very bone compatible, have very slow exothermic reactions, setting without shrinkage, and promote osteoconduction. Mechanically, CPCs have a compressive strength equal to or greater than bone, but a significantly lower tensile strength (1-10 MPa), especially when compared to that of PMMA. As such, CPCs can be used only in non- to low-loadbearing applications.

Dental composite resin cements (also called dental composite resins) can also be used in place of or in addition to the PMMA cement and/or the calcium phosphate cement. Dental composite resins are composed of a resin matrix that is mixed with other materials to produce properties superior to the individual components. A composite resin typically consists of four main components: an organic resin matrix, an inorganic filler, a coupling agent that creates bonding between the inorganic and organic components, and an initiator/accelerator, which results in the curing of the material. Preferably, the resin matrix comprises BIS-GMA, urethane dimethacrylate, and triethylene glycol dimethacrylate. Although dental composite resins have been shown to be biocompatible, there are reservations about long-term effects due to the chemical components that leach out and accumulate in the local and distant tissues.

All of the above cements are either inert or osteoconductive or osteoinductive. However, if the bone tissues next to the implant are compromised, osteoconductive or osteoinductive cements are desired or preferred because they can promote and improve the rate of bone healing.

For purposes of the present invention, the PMMA cement is most preferred due to its low cost, good physical strength, ready availability, known long-term biocompatibility, and simplicity of manipulation. Although calcium phosphate and/or other bone cements mentioned above are also suitable for use with the hybrid implant of the present invention, they are much more expensive and provide less mechanical strength than that of the PMMA bone cement.

Many brands of the PMMA cement are commercially available. They generally include two components, a powder and a liquid, which are mixed together to create the final cement. The powder portion comprises pre-polymerized PMMA or a PMMA-based polymer, a radio-pacifier of barium sulphate or zirconium oxide particles and an initiator of benzoyl peroxide. The liquid portion comprises methyl methacrylate monomer, N,N-dimethyl-p-toluidine, as an accelerator and hydroquinone as an inhibitor of the polymerization reaction. The mechanical characteristics of the PMMA cement are: compressive strength>70 MPa, tensile strength>50 MPa, bending strength>50 MPa, and modulus of elasticity>1800 MPa. Recently, antibiotics have been added to the PMMA cement to treat or prevent infection at the vicinity of the implant. Unlimited examples of antibiotics are gentamicin, tobramycin, vancomycin, fusidic acid, erythromycin with colistin and clindamycin.

Currently, although PMMA cement is widely used for orthopedic surgeries, it is not being used in dental implant systems. The prior uses of PMMA cement to augment dental implants have failed so far because (1) the lack of bioactivity and bonding between the cement and the bone, which results in an intervening fibrous layer between the bone and PMMA; (2) thermal necrosis caused by a highly exothermic setting reaction of 60° C. or higher; (3) chemical necrosis and tissue toxicity to the residual monomer and N,N-dimethyl-p-toluidine (DMPT) release; (4) the hardened cement is a brittle material with insufficient fatigue resistance that is susceptible to failure when tensile forces are present; and (5) a significant volumetric shrinkage of the cement during polymerization, which induces stresses and undermines the integrity of the cement-bone interface, resulting in aseptic loosening after a long-term implantation.

The PMMA cements can be modified (the modified PMMA cement) to overcome some of their shortcomings, such as toxicity of monomer DMPT, poor adhesion, non-bioactivity, highly exothermic reaction, and/or lower tensile strength, etc. The long-term success and stability of the modified PMMA cements are not available.

To solve the poor adhesion problem, chemicals such as triethylene glycol dimethacrylate, ethylene glycol dimethacrylate, and/or poly(ethylene glycol) dimethacrylate, can be added to crosslink with PMMA. Alternatively, methylmethacrylate (MMA) can be partially replaced by hydroxypropylmethacrylate or 4-trimethacryloyloxyrthyl trimellitate (the MMA mixture), and/or tributyl borane can be added to MMA or the MMA mixture. To provide bioactivity to the PMMA cement, some bio-inducing material or chemicals can be added, such as a mixture of hydroxyapatite/apatite wollastonite glass/recombinant human growth hormone/hydroxyapatite+chitosan; an additional polymer (such as bispheno glycidyl dimethacrylate/PEMA/PEMA with n-butyl methacrylate/META-PMMA/methacrylic acid/diethyl aminoethyl methacrylate); a mixture of 3-methyloxyl propyl-trimethoxysilane/3-aminopropyltriethoxysilane/3-glycidoxypropyltrimethoxysilane/soluble calcium salt, or a mixture or combinations thereof. PEMA stands for phenoxyethylmethacrylate.

The high elastic modulus of the PMMA cement can be reduced by using polybutyl methacrylate instead of PMMA, and/or using PEMA with n-butyl methacrylate. To resolve the issue related to the low tensile strength, fracture toughness, and fatigue life, the PMMA cement can be reinforced by adding fibers of graphite/stainless steel/titanium/Kevlar 29/polyethylene/ultrahigh-molecular weight polyethylene, and/or adding particulates of rubber-toughened PMMA powder/poly(isobutylene)/acrylonitrile-butadiene-stryene/poly(caprolactone)/polybutyl methacrylate/alumina powder/chitosan.

The toxicity of DMPT can be reduced by reducing the amount of DMPT (up to about 50%), providing solution to the PMMA solutions (such as pre-dissolving two PMMAs in MMA solutions), adding antioxidant (such as vitamin E), and/or using any alternative accelerator (such as a higher molecular weight accelerator, polymerizable tertiary amines, and tertiary amine with a long chain fatty acid). Other different types of radiopacifiers can be used, such as a bromine-containing chemical, iodine-containing chemical, bismuth compound, tanulum powder, heavy metal-containing organic material, and a mixture thereof.

The high exothermic setting reaction of the PMMA cement can be reduced by adding one or more additives, such as a co-monomer that dissolves in MMA, or a highly viscous, hydrophilic, biocompatible, immiscible fluid. The fluid can be an aqueous solution of hydroxypropylmethylcellulose, Dextran, sodium hyaluronate, or a mixture thereof. Preferably, the fluid can be a sodium hyaluronate (HA) solution formed by dissolving HA powder in distilled water, with the preferred HA solution concentration being at 2.0% w/w. The 2.0% HA solution will offer a fluid with a viscosity close to 20 Pa s. The mixture of the HA with the PMMA cement then forms an injectable PMMA cement without high exothermic setting reaction. Preferably, the PMMA cement contains about 45% to about 50% HA. The resulting modified PMMA cement has a maximum polymerization temperature of about 35° C. while showing great mechanical stability and strength. The addition of HA also reduces the viscosity and increases the injectability of the bone cement.

The suitable bone cement is injected into the implant to the extent that the bone cement fills the hollow inner channel and moves through the side openings of the middle portion into the cracks and/or spaces in the surrounding bone, such as inter-trabecular space. The amount and viscosity of the bone cement should be carefully determined prior to the operation to prevent too much bone cement moving into the inter-trabecular space during the injection step. Too much bone cement might create fractures in the surrounding bone, which is still weak and damaged from the operation, especially for the bone already weakened from diseases, osteoporosis, etc.

The amount of the bone cement is determined mainly by the size of the hollow inner channel, the size of the bored hole in the jaw bone, the quality of the jaw bone, and the bone damage caused by the implantation process. The quality of the jaw bone determines the size of the bore hole, and the extent of bone damage and cracks/spaces generated from the implantation process. If the quality of the jaw bone is excellent, the insertion of the implant might create less damage, resulting in relatively less and/or smaller cracks and/or spaces in the surrounding jaw bone. Conversely, the poor quality of jaw bone might result in more damage and bigger cracks and/or spaces in the surrounding jaw bone.

In some embodiments of the present invention, after the unhardened bone cement is injected into the hollow inner channel, a push cylinder is needed to apply pressure on the unhardened bone cement paste to enable it to penetrate the cracks and/or spaces in the surrounding jaw bone, usually referred to as the inter-trabecular space (see FIG. 2). The push cylinder can be inserted into the hollow inner channel through the open ceiling, pressuring the unhardened bone cement through the side openings in the middle portion into the surrounding bone's cracks and/or spaces, usually inter-trabecular spaces. The pressure from the push cylinder has to be appropriate so that it would not push too much unhardened bone cement into the inter-trabecular spaces, where the bone structure is still weak and damaged from the surgery.

As such, the unhardened bone cement fills the hollow inner channel, penetrating into the cracks and/or spaces in the bone adjacent to the middle portion and maybe to a part or parts of the lower portion. Within about one to fifteen minutes, the unhardened bone cement quickly polymerizes and/or hardens (or sets) into a solid (the hardened bone cement), which then anchors the implant to the surrounding bone adjacent to the middle portion, and maybe to a part of the lower portion. The cracks and/or spaces in the bone surrounding the implant are generally very small, and thus have room for only a small amount of the bone cement. Along with the threaded parts of implant, this small amount of the bone cement is sufficient to anchor the implant to adjacent cortical and trabecular bones for a short period of time. As discussed above, this anchorage or stability augmentation is only needed temporarily, no more than 6 months or so, just long enough that the patient can heal normally while using the implant during his or her daily chewing activities.

In other words, the hardened bone cement augments the initial stability of the hybrid implant of the present invention to prevent implant failure under the immediate masticatory loading before healing. The dental abutment and other dental prosthesis, such as a crown and/or a false tooth, can then be installed right after the bone cement is hardened. The whole implant system (“restored tooth”) can be installed in one surgical procedure, after which the dental patient can use the “restored tooth” almost immediately to chew food. The masticatory force generated from chewing is absorbed by the anchorage between the bone and the threaded parts of the implant, which is augmented by the bone cement, and thus the force does not disrupt the implant or the bone-implant interface during its healing period.

As shown above, only a portion of the hybrid implant is preferably covered by bone cement—the middle portion and maybe a part of the lower portion. At least, the upper portion and some part of the lower portion of the implant remain exposed to adjacent live bone. During the healing period, this exposure to live bone enables initial support and biological osseointegration at the bone-implant interface of the implant. Therefore, the present invention provides for a hybrid implant capable of providing both mechanically and chemically generated initial stability (screw threads and bone cement augmentation) and biologically generated permanent stability (osseointegration).

### EXAMPLE

This example is a simulated study, which examines the initial mechanical stabilities of the bone-implant interface for the hybrid implant of the present invention using the PMMA bone cement. The example is provided to illustrate various embodiments of the invention and is not intended to limit the scope of the invention in any way.

As explained above, the interface between the bone and the implant plays a critical role in determining mechanical stability of an implant system. The mechanical loading of installing an implant triggers a biological reaction in the bone at the bone-implant interface, which leads to alterations of bone properties around the installed implant.

In this study, a microcomputed tomography (micro-CT) based inhomogeneous large-scale finite element (LS-FE) analysis was used to evaluate the initial mechanical stability of the bone-implant interface for the implant of the present invention. Three-dimensional images of high resolution micro-CT were used to simulate how the altered bone properties affect mechanical environments of the bone-implant interface. The high resolution micro-CT images had 20 μm voxel size, and they were used to simulate the implantation of a titanium dental implant in bone. The CT attenuation numbers (HU units) of bone were maintained during the scanning/reconstruction and segmentation processes, and converted to tissue mineral density (TMD).

The magnitude of tissue modulus for each bone element was determined using the following exponential relationship between nanoindentation modulus and the TMD for the inhomogeneous FT models: modulus=0.00087×TMD^{1.45}. This relationship shows that the bone tissue stiffness is strongly correlated with degree of mineralization; further, the precise relationship between modulus and TMD might vary depending on the age of the bone tissue (see Mulder et al., J Biomed Mater Res A. 2008 February; 84(2):508-15; Smith et al., J. Biomech. 2010 Dec. 1; 43(16):3144-9. Electronically published on 2010 Aug. 17).

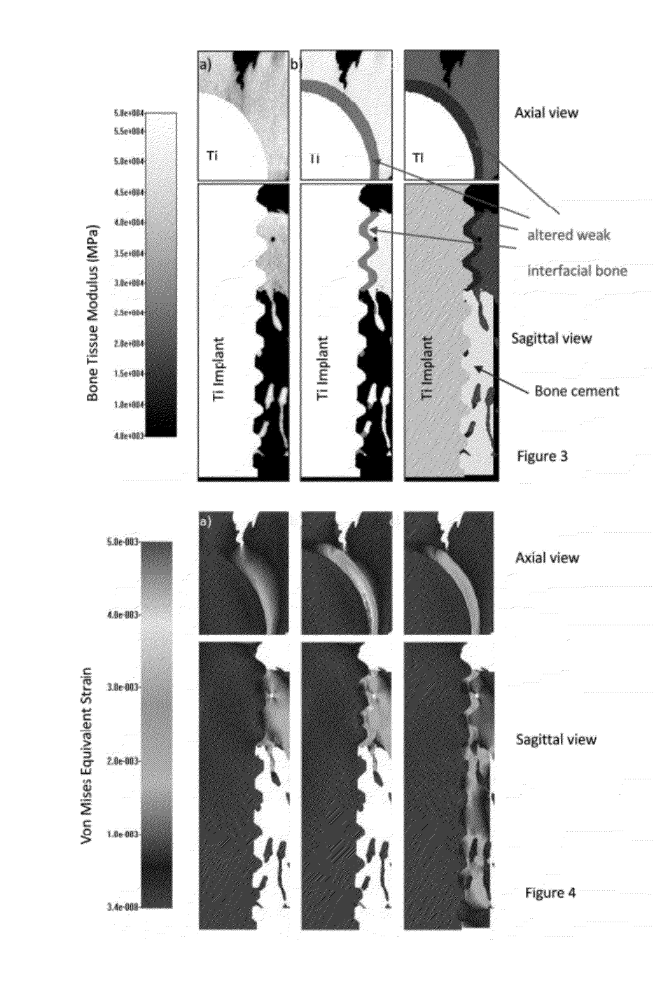

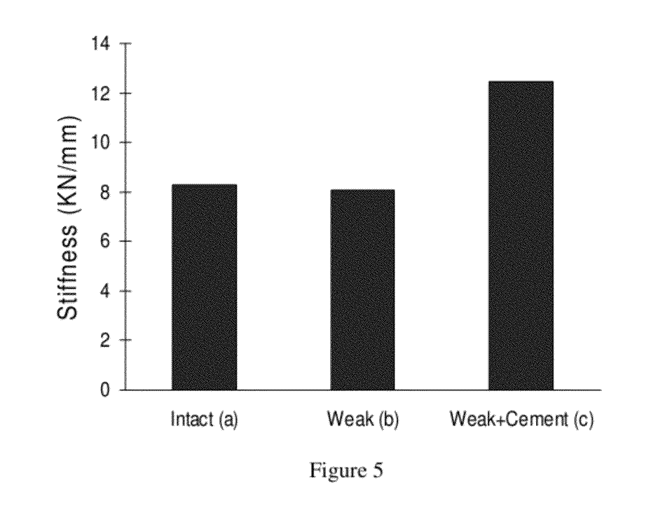

Three finite element (FE) models were simulated (FIGS. 3 and 4). The first model represented the intact interfacial bone (FIG. 3a). The second model (FIG. 3b) represented the altered (less mineralized) new bone properties during healing after inserting the implant without bone cement, and the altered region was estimated to be at the 300 μm interfacial region around the implant. The altered modulus of bone was assumed to be much weaker with only about 50% of the intact modulus of unaffected bones shown in the first model. The third model (FIG. 3c) represented the altered new bone properties during healing after inserting the hybrid implant of the present invention with the PMMA bone cement, and the altered region was estimated to be at the 300 μm interfacial region around the implant.

The modulus of the titanium implant was 104 GPa and that of the PMMA bone cement was 2 GPa. The micro-CT voxels were converted to finite elements. Displacement corresponding to the same level of compressive force (−7.26N) was applied on the top of the implant for all of the three FE models. Stiffness was obtained by dividing the force by displacement. The large scale FE results (FIG. 4) were analyzed using the equivalent strain of von Mises stress, which is typically used as a failure criterion of a material.

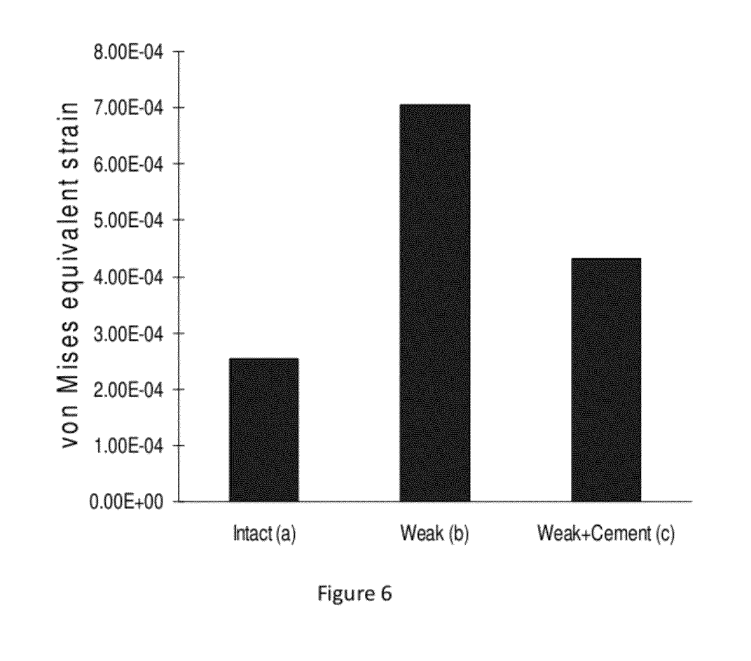

FIGS. 3 and 5 showed that the stiffness of the implant system with the altered weak bone interface (8.07 KN/mm, FIGS. 3b and 5b) was lower than that with the intact bone interface (8.28 KN/mm, FIGS. 3a and 5a). The stiffness of the implant system after the bone cement augmentation showed a significant increase, more than 1.5 times stronger (12.44 KN/mm, FIGS. 3c and 5c) than that of the other implant system, including the implant system with the intact bone interface. On the other hand, the maximum von Mises equivalent strain for the hybrid implant system with cement (432 με, FIGS. 4c and 6c) was much lower than that for the altered weak bone interface implant (704 με, FIGS. 4b and 6b), about 1.63 times lower. The lowered maximum von Mises equivalent strain for the hybrid implant showed a decreased risk of damage for the hybrid implant at the interfacial bone. These results demonstrated that the augmentation of the implant through bone cement can improve the stability of the implant system by increasing the implant's resistance to the applied forces while decreasing the risk of damage at the interfacial bones. The study also showed that even a small amount of the bone cement surrounding the implant, such as at a 300 μm interfacial region, is sufficient to obtain significantly improved mechanical stability of the whole implant system.

Beyond the dental application, the hybrid implant can also be used in orthopedic applications. PMMA bone cement augmentation has been known in orthopedic surgery. However, some drawbacks, such as lack of adhesion to bone surfaces (no bioactivity), poor biocompatibility, absence of osteoconductivity, short of biodegradability, weaker implements than cortical bone, high exothermic polymerization reaction, and monomer toxicity, limit its applications, particularly in spinal surgery. More importantly, PMMA or other similar bone cement is not suitable for maintaining biomechanical properties after implantation in the body for a long time.

The hybrid implant of the present invention includes a screw body with one or more external threads. The screw body has an upper portion with an open ceiling, a middle portion with an inner cavity and one or more side openings, and a lower portion with a closed floor. The open ceiling is configured to receive unhardened bone cement. The side openings of the middle extend from the inner cavity, wherein the open ceiling is in communication with the inner cavity to form a hollow inner channel, which allows a portion of the unhardened bone cement to move through the side openings and to penetrate into the surrounding bone. The hollow inner tunnel extends from the upper portion through the middle portion to the lower portion.

The hybrid implant of the present invention is a simple and inexpensive device to provide a hybrid function of an initial bone cement stability augmentation at the middle portion of the implant, and a later osseointegration of the bone-implant interface at the upper and lower portions of the implant. After the implant is installed into the bone, the tight coupling between threaded parts of the implant and the bone provides for the initial mechanical stability. However, this stability is insufficient to support the implant through normal human activities during the healing period before a successful osseointegration at the implant-bone interface has taken place. The bone cement of the middle portion augments this initial mechanical stability of the implant in the bone by further bonding the implant to the bone and to the cracks in the bone, resulting in a significant decrease in the micro-motion between the bone and the implant surface, which enable rapid osseointegration at the bone-implant interface. Therefore, almost immediately after the orthopedic surgery, a patient can have some usage of the area of the body with the installed implant without causing implant failure.

It is important to note that the goal of the bone cement augmentation of the middle portion is to provide temporary initial stability to the implant, while that of the osseointegration of the upper and lower portions of the implant is to provide long term permanent stability to the implant. Therefore, the middle portion is preferably sized just large enough to enhance the initial stability of the implant sufficiently to promote rapid osseointegration of the implant through its upper and lower portions mostly, and to withstand loading forces from daily activities. To accomplish that objective, the middle portion preferably occupies no more than about 50% of the entire length of the implant, more preferably no more than about 30-40%.

In some other alternative embodiments, the present invention provides for a hybrid screw for construction applications. During construction, screws are used to connect the construction materials together, or to fix an object into the construction material. As the screw is being inserting into the material, the insertion creates micro-fractures that extend further into the construction material, such as wood. Overtime, daily forces such as wind generate micro-motion between the screw and the construction material, causing the surrounding micro-fractures to extend and/or expand. The hybrid screw of the present invention is a simple device to increase the mechanical stability of the screw initially and over a long term by reducing these micro-fractures around the screw.

The hybrid screw includes a screw body with one or more external threads, including a hollow inner channel with an open ceiling and a closed floor, an upper portion with an open ceiling configured to receive unhardened construction cement, a middle portion having an inner cavity and one or more side openings extending from the inner cavity, wherein the open ceiling is in communication with the inner cavity to form a hollow inner channel, which allows a portion of the unhardened construction cement to move through the side openings and to penetrate into the surrounding construction material; and a lower portion with a closed floor. The hollow inner tunnel extends from the upper portion through the middle portion to the lower portion. The construction cement refers to the cements or binder suitable for fixing or attaching an object to the surface of a construction material, such as Portland cement, masonry cement, pozzolan-lime cement, etc.

The construction cement of the middle portion would then augment the existing mechanical stability by sealing parts or all of the micro-fractures and/or cracks around the screw. Further, it provides for a longer term stability of the screw by reducing the micro-motions between the screw surface and the construction material. In the present invention, the construction cement is limited to the middle portion of the screw. This configuration prevents the construction cement from oozing out the surface of the construction material around the screw. Further, it reduces the chance that the construction cement might expand the cracks in the construction material around the screw. As the result, the middle portion preferably occupies no more than about 80% of the entire length of the implant, more preferably no more than about 50%.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A hybrid dental implant having a screw body with at least one external thread, comprising
a) an upper portion with an open ceiling configured to receive an unhardened bone cement,
b) a middle portion having an inner cavity and one or more side openings extending from the inner cavity, wherein the open ceiling is in communication with the inner cavity to form a hollow inner channel, which allows a portion of the unhardened bone cement to move through the side openings and to penetrate into the surrounding bone; and
c) a lower portion with a closed floor.

2. The hybrid dental implant in accordance with claim 1, wherein the middle portion occupies no more than about 50% of the entire length of the implant.

3. The hybrid dental implant in accordance with claim 1, wherein the middle portion occupies no more than about 40% of the entire length of the implant.

4. The hybrid dental implant in accordance with claim 1, wherein the open ceiling is configured to couple with a bone cement syringe.

5. The hybrid dental implant in accordance with claim 1, wherein the side openings of the middle portion are formed of two or more columns.

6. The hybrid dental implant in accordance with claim 1, wherein the bone cement is an injectable, biocompatible bone filling or substitution material.

7. The hybrid dental implant in accordance with claim 1, wherein the bone cement comprises PMMA cement, modified PMMA cement, calcium phosphate cement, glass-ionomer cement, composite resin cement, osteoinductive cement, and a mixture or combinations thereof.

8. The hybrid dental implant in accordance with claim 1, wherein the bone cement comprises PMMA cement with one or more suitable additives.

9. The hybrid dental implant in accordance with claim 1, wherein the lower portion comprises one or more self-tapping cuts at a front end of the lower portion.

10. The hybrid dental implant in accordance with claim 1, further comprising a coating of bone-inducing material on at least a portion of an outer surface of the implant.

11. A method for installing a hybrid dental implant into a bone, the method comprising:
a) screwing a hybrid implant with a screw body having at least one external thread into a bored hole in the bone; and
b) injecting a suitable amount of unhardened bone cement into an open ceiling of the implant, thereby pushing the cement into an upper portion of the implant, whereby the cement moves through a hollow inner channel, which is formed of an inner implant having one or more side openings, through which the cement penetrates the surrounding bone but does not move substantially past a lower portion of the implant that forms a closed floor.

12. The method in accordance with claim 11, further comprising the steps of
a) waiting for a period of time sufficient to allow the hardening of the bone cement; and
b) attaching a dental abutment and/or prosthesis to the implant.

13. The method in accordance with claim 11, further comprising a step of using a push cylinder to apply pressure on the bone cement to enable it to penetrate cracks and/or spaces in the surrounding bone.

14. A hybrid implant for orthopedic applications, having a screw body with at least one external thread, comprising
a) an upper portion with an open ceiling configured to receive an unhardened bone cement,
b) a middle portion having an inner cavity and one or more side openings extending from the inner cavity, wherein the open ceiling is in communication with the inner cavity to form a hollow inner channel, which allows a portion of the unhardened bone cement to move through the side openings and to penetrate into the surrounding bone; and
c) a lower portion with a closed floor.

15. The hybrid dental implant in accordance with claim 14, wherein the middle portion occupies no more than about 50% of the entire length of the implant.

16. A hybrid screw for construction applications, having a screw body with at least one external thread, comprising
a) an upper portion with an open ceiling configured to receive an unhardened construction cement,
b) a middle portion having an inner cavity and one or more side openings extending from the inner cavity, wherein the open ceiling is in communication with the inner cavity to form a hollow inner channel, which allows a portion of the unhardened construction cement to move through the side openings and to penetrate into the surrounding construction material; and
c) a lower portion with a closed floor.

17. The hybrid screw in accordance with claim 16, wherein the middle portion occupies no more than about 80% of the entire length of the implant.
